(19) United States
(12) Patent Application Publication
(10) Pub. No.: US 2016/0208120 A1
(43) Pub. Date: Jul. 21, 2016

(54) WATER BASED MAGNETIC INK CHARACTER RECOGNITION INK JET INK BASED ON DISPERSION OF FUNCTIONALIZED NANOPARTICULATE MAGNETIC FERRITE

(71) Applicant: Nanum Nanotecnologia S/A, Minas Gerais (BR)

(72) Inventors: Taiane Guedes Fonseca De Souza, Belo Horizonte (BR); Suzeley Leite Abreu, Vespasiano (BR); José Fernando Contadini, Lagoa Santa (BR); Tarik Della Santina Mohallem, Horizonte (BR)

(21) Appl. No.: 14/933,858

(22) Filed: Nov. 5, 2015

(30) Foreign Application Priority Data
Jan. 16, 2015 (BR) 102015001022-2

(51) Int. Cl. C09D 11/38; H01F 1/44

(52) U.S. Cl. CPC C09D 11/38; H01F 1/445

(57) ABSTRACT

The present invention describes a method to obtain magnetic aqueous ink composition for MICR (Magnetic Ink Character Recognition) ink jet printing comprising an aqueous dispersion of functionalized magnetic nanoparticles, humectant agents, solvents, biocide and water. It also allows obtaining stable inks for long periods with extremely high concentrations of magnetic nanoparticles with loading between 15% and 40% by mass and magnetic signals varying from 80 to 200%. Through the use and special combination of humectant agents, the present inventions increase the print head protection, by decreasing abrasiveness and increasing fluidity. The resulting ink has superior printing quality and increased service life of the printing system.

### BACKGROUND OF THE INVENTION

This request is, in parts, a continuation of the U.S. Pat. No. 8,815,393 B2, “Process for obtaining functionalized nanoparticulate magnetic ferrites for easy dispersion and magnetic ferrites obtained through the same” which derives from the Brazilian patent application, PI 1002273-2, “Processo de obtenção de ferritas magnéticas nanoparticuladas e funcionalizadas para fácil dispersão e ferritas magnéticas obtidas através do mesmo”. That patent, from the same company (Nanum Nanotechnology SA) and from the same inventors, describes a novel process to produce nanoparticle magnetic ferrites and its dispersions, also known as ferrofluids, for various applications mentioned therein, including the production of magnetic inkjet inks. The present invention presents in detail the process to transform the innovative water based magnetic dispersion described in that patent into innovative water based magnetic inkjet ink for MICR (Magnetic Ink Character Recognition) applications.

Technologies for inkjet printing and the production of inkjet inks have been around for several decades. They contain, in general, dyes and/or pigments, surfactants, humectants, biocides, among others. The inkjet ink formulation also requires very specific situations in terms of viscosity, surface tension, drying rates, etc. Similarly, magnetic MICR printing technologies have decades of evolution involving the particles and the physical and magnetic characteristics thereof.

The technology to produce water based magnetic inkjet ink for MICR applications usually can be divided into two consecutives and interdependent processes. The first one is the manufacture or suspension (by dispersing, milling, etc) or adjustment of the magnetic particles in a stable aqueous dispersion (ferrofluid) with a high solids concentration, always higher than the final ink. The second one is the ink formulation directed to the specificities of inkjet printing technologies. The two main digital print technologies are thermal and piezoelectric, which may happen by continuous flow (bulk) or by cartridges with defined volumes. These printing characteristics define the physicochemical properties that the ink should have during the printing process such as dynamic viscosity, surface tension and evaporation during the drop formation, and the drying speed and the characteristic of the ink penetration into the substrate after drop formation. The ink formulation results in the setting of these parameters and is closely linked to the characteristics of the initial dispersion and its stability.

One of the main challenges of magnetic ink jet printing technology is that the cartridge nozzles are extremely small, on the order of 1 μm in diameter maximum, requiring then magnetic pigments of sub micron order to avoid clogging. Since the magnetic signal response is proportional to the particle size and its mass, the other challenge is to achieve a stable dispersion for high concentrations of pigments, in such a way that in a single printing process the magnetic signal reaches the intensity required for MICR readers available on the market. Typically, concentrations between 15% and 35% are used in standard MICR ink on the market. Such pigment concentration becomes detrimental to the orifices of the print head of ink jet system due to their rheological characteristics, such as high viscosity and high drying rate making the shear stress a factor of great importance. Furthermore, these pigments may consist of considerable hardness materials where the print head damage due to their abrasiveness should be considered.

### SUMMARY OF INVENTION

The present invention starts from an innovative process to obtain a water-based dispersion with high stability, based on strong chemical bonds as opposed to other technologies that use chemical interactions only, such as Van der Waals forces, to maintain the stability of the dispersion, which means, long range forces much weaker than chemical bonds. These interactions are obtained using coatings, surfactants, etc. as opposed to use an initial surface treatment of the magnetic particles with subsequent chemical binding of a selected compound (functionalizer) which will be responsible to also interact with water. We call this process as functionalization.

The magnetic particles production and its water based ferrofluid (or aqueous dispersion) is already discussed in great detail at the U.S. Pat. No. 8,815,393 B2 as well as its process and its differentiation in relation to other existing patents. We add on this request some other quotes that drive the title of the invention and the specific claims for aqueous MICR printing inks in inkjet printers.

The patents of Xerox Corporation U.S. Pat. No. 8,409,341 B2 and U.S. Pat. No. 8,597,420 B2 include MICR inks for inkjet printing, but are specific to solvent-based ink formulations. On the other hand, the U.S. Pat. No. 8,236,192 B2 includes water based formulations too. They are inks based on single crystals of stabilized magnetic nanoparticles, single crystals containing domains at least 10 nm, and the absolute value of magnetic anisotropy greater than or equal to 2×10⁴ J/m³. These simple magnetic crystals are composed of at least one metal nanoparticle involving Fe, Co or Mn. Such nanoparticles may also be bimetallic or trimetallic selected from the following group of choices FePt, CoPt, MnAl, MnBi, CoO.Fe₂O₃and BaO.6Fe₂O₃, plus Fe and Co. Intervals of remanence, coercivity and magnetic moment of saturation are set for them. Several ink compositions are disclosed, primarily for nonpolar carriers where dyes, resins and surfactants are added. For aqueous dispersions, anionic surfactants and other ingredients are added while the particles are milled with ball mill for several hours.

The present invention differs from Xerox technology in various aspects. First, it is a water borne dispersion, which precludes any similarity to the first two Xerox quotes that are based on non-polar solvents. In the third Xerox patent, U.S. Pat. No. 8,236,192 B2; all of the magnetic pigment dispersions undergo a process of comminution, by milling or using high shear rate mixers. Furthermore, the stabilization of the particles does not occur with a functionalization of them, as well as discussed in the example below.

The Nu-Kote International, Inc. patents, number U.S. Pat. No. 6,746,527 B1; U.S. Pat. No. 6,767,396 B2 and U.S. Pat. No. 6,726,759 B2 deal with the compositions of aqueous inks for inkjet MICR printing using metal oxides. The particles or the metal oxide pigments should have a size less than 0.5 microns and remanence of at least 20 emu/g. One such patent (U.S. Pat. No. 6,767,396 B2) teaches us about the preparation of the possible metal oxide pre-dispersions as a basis for the formulations of the claimed MICR inks. In all cases the pre-dispersions start with the mixture of water with at least one surfactant and will slowly by adding the magnetic powder pigment, or the metal oxide particles selected from specified groups. This magnetic pigment can also be made of metal oxide particles coated with hydrophilic inorganic silicates such as aluminum silicate, sodium silicate and potassium silicate. Once ready these pre-dispersions a sequence of grinding processes and filtration begin, conventional and/or unconventional, in order to mix the ink and further reduce the particle size. The other two Nu-Kote patents (U.S. Pat. No. 6,726,759 B2 and U.S. Pat. No. 6,746,527) seek to be wider in the previous patent requested claims increasing the list of surfactant possible to use. The same applies to the materials for the hydrophilic coating dispersion in the wet cake form, the metal oxide used and its remanence intervals. Also extend to the composition of the final ink produced from these pre-dispersions working with dyes and aqueous solvents.

About the pre-dispersion, Nu-Kote technology uses a process typically classified as “top-down”, in which sub-micrometer metallic oxide particles are crushed and filtered while interacting with aqueous base containing a surfactant or a combination of them. At this stage the particles have already some differences, especially regarding the shape of the particles size distribution curve, besides that on the present invention the magnetic metal oxides particles are chemically synthesized by precipitation, classifying the case as “bottom-up”. However, it is in the dispersion technology and in the stabilization of these dispersions that the distance to the present invention provokes most of the differences. Inks originating from each of the technologies will exhibit quite different rheological characteristics and formulations.

The pre-dispersions are very distinct from the present invention. All teaching and claims of Nu-kote revolves around the basic need to use a surfactant or a combination thereof throughout the process to ensure the stability of the aqueous dispersion, while dispersion in the present invention is independent of the surfactant in such a way that even if it is added subsequently to ink formulation in small quantity it will act only as a corrective surface tension, not to stabilize the dispersion of magnetic pigment. The Nanum keeps in its laboratory one of its first aqueous magnetic dispersions produced in September 2009 where no surfactant was added. After several years dispersion remains stable, although part of the water has evaporated and the solid concentration which was originally 50% being currently around 65%. This distinction can also be observed easily by noting that even with solids concentrations as high as 65% dispersion of the present invention further presents its fluid character, while the patent Nu-kote to work with concentrations around 58% was classified as paste (wet cake form).

Although the coating process is quite different from the functionalization process of the magnetic particles used at the present invention, Nu-kote technology may alternatively use hydrophilic compounds to obtain coated particles. The compounds listed for the coatings are aluminum silicates, inorganic silicates, metal stearates, ester metal phosphates, metal sulfonates, and the like, where no such compounds are used in the functionalization process of the present invention.

It is also possible to perform an estabilization of two layers made according to the teachings of Shimoiizaka et al. (U.S. Pat. No. 4,094,804) in which the oleic acid is used as the first functionalizing layer, by chemical bond, creating the connections between the particles and unsaturated fatty acids in the second layer, by long range interactions. Thus, the aqueous dispersion of Shimoiizaka always happen in the presence of this second component, which now acts as a recoating which will be limited by physical adsorption of the second layer, thereby compromising the stability of the dispersion with a weaker bond, as described by himself (col 3-ln 45).

The technology route taught here uses a single layer of functionalizing strongly attached to the particle via chemical bonds. Thus, with more flexibility, for polar bases we can choose between amino acids, tartaric acid, citric acid or oxalic acid. This step is preceded by attack on the surface by using mineral acids (instead of organic acids such as oleic acid) or strong bases, depending on the particle composition. As these processes will release various ions in the solution, a washing process becomes very important in this technology to remove ions and other salts, which can block the particle surface or contribute to the instability of the same system due to the increased conductivity. In the Shimoiizaka process the particles can not and is not washed at this point, because such process could lead to losses of part of the surfactant loosely bound to the outer layer.

Having this unique dispersion, super stable in aqueous basis, the present invention solves MICR printing ink formulation relatively simple and uncomplicated, requiring only the adjustments of viscosity, surface tension, drying time, and biocides, depending on the printing technology and substrates to be considered. One of the most important and necessary characteristics in the ink formulation of the present invention is the use of special humectant compounds to ensure the moist property of the printing head surface having an ink with high solids concentration, but also to avoid the accumulation of material after the jetting, avoiding the impregnation of organic and inorganic part and leaving the printing head clean and unblocked. From the large amount of existing humectant compounds the polyols which exhibit excellent performance for this technology are bis-(cyanoethyl)-dihydroxypropylamine (known as “C-1”), bis-(2-hydroxyethyl) glycolamide (known as “BHEGA”), bis-(hydroxyethyl)-lactamide (known as “BHELA”) and bis-(hydroxyethyl) dimethyl hydantoin (referred to as “DANTOCOL EHD”).

The most interesting of the present invention is that the nanostructure formed by the nano composite magnetic pigment, their water based functionalizer and humectant compounds create a unique system that reduces the dispersion shear stress with greater fluidity and low abrasiveness, preserving the printhead of the inkjet printer.

### AIM OF THE INVENTION

The main aim of this invention is to provide a method of obtaining magnetic water based inks to jetprint MICR (Magnetic Ink Character Recognition) starting from dispersions of functionalized magnetic ferrites nanoparticles, obtained according to U.S. Pat. No. 8,815,393 B2. Some of these dispersions are already available in the global market being offered by the Nanum Nanotecnologia SA, such as Nanumadit AT-0701, AT-0716, AT-2701, AT-2801, etc.

Another aim of the present invention is the production of aqueous MICR inks with extremely high concentrations of magnetic nanoparticles with loading between 15% and 40% by mass, keeping them stable for several months and creating a system that protects the printhead of inkjet cartridges against the effect of high ceramics load, having less abrasiveness and greater fluidity.

### DESCRIPTION OF THE DRAWINGS

FIG. 1: hydrodynamic size distribution of particles, by the technique of Dynamic Light Scattering (DLS) of Nanumadit NA-0701 additive.

### DETAILED DESCRIPTION OF THE INVENTION

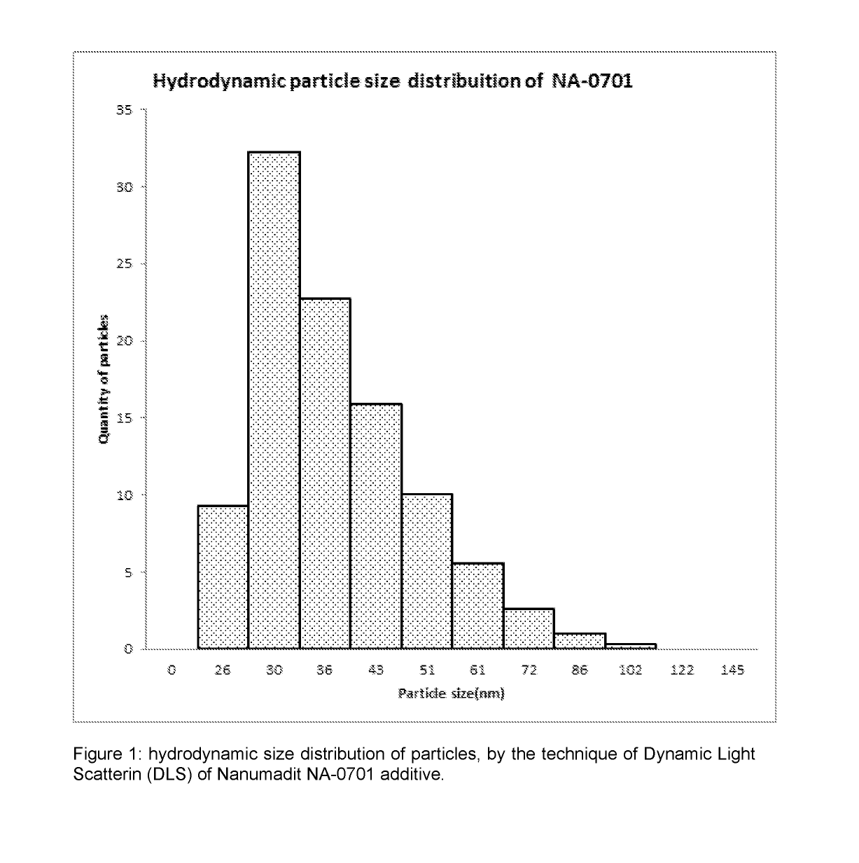

To obtain aqueous MICR inks for inkjet printing starts from aqueous dispersion of functionalized nano-sized magnetic ferrite produced according to the process described in U.S. Pat. No. 8,815,393 B2. Nanometrics, simple or compound magnetic ferrites are chemically synthesized by co-precipitation where their physical and magnetic characteristics can be adjusted as needed. These adjustments are possible by modifying the composition of the metal oxide according to the following criteria for simple ferrite (MFe2O4 or MFe12O19) or for compound ferrites (N×M(1-x)Fe2O4 or N(1-y)Mx+YFe(2-x)O4, for example) where M and N can be metal atoms such as Sm, La, Bi, Ba, Mo, Sr, Ni, Co, Fe, Mn, Cr, etc. These ferrites exhibit a particle size distribution ranging from 15 to 300 nm, preferably between 15 and 120 nm, as shown in FIG. 1 below, with a surface area between 10 and 120 m2/g, preferably between 25 and 90 m2/g. Presenting also magnetic saturation between 05 and 80 emu/g, magnetic remanence ranging from 1 to 60 emu/g magnetic coercivity of from 10 to 3000 Oe, a magnetic saturation, preferably between 30 to 80 emu/g, magnetic remanence from 10 to 30 emu/g, and magnetic coercivity between 200 and 800 Oe.

The following Table 1 shows some practical results:

TABLE 1
Magnetic properties of the additives
used in the MICR ink production.

| | Hc | Mr | Ms | |
|---|---|---|---|---|
| Nanumadit | (Oe) | (emu/g) | (emu/g) | Composition |
| NA-2601 | 34 | 3 | 55 | Manganese, Boron ferrite |
| NA-2701 | 724 | 4 | 15 | Barium, Cobalt ferrite |
| NA-2801 | 553 | 15 | 41 | Cobalt. Cerium ferrite |
| NA-0701 | 347 | 19 | 62 | Manganese, Cobalt ferrite |
| NA-2901 | 238 | 14 | 54 | Manganese, Gadolinium, |
| | | | | Cobalt ferrite |
| NA-3001 | 1201 | 25 | 42 | Barium ferrite |

Hc: coercive field,
Mr: remnant magnetization,
Ms: saturation magnetization

After this co-precipitation process, a surface treatment of the particles occurs with the addition of a strong acid or base solution, followed by a first wash, thereby preparing the material for functionalization. The functionalization for aqueous base can be accomplished with a functionalizer, or a combination thereof, chosen from oxalic acid, citric acid, tartaric acid and amino acids. The material obtained by the functionalization with adjusted pH is then washed again. This second wash may occur by filtration, dialysis and/or decantation mixing water and organic solvents. So far all follow the procedures set forth in U.S. Pat. No. 8,815,393 B2 and the resultant ferrofluid with solids concentration between 35% and 55%, preferably 50%, is directed to the manufacture of ink without the necessity of transformation into a powder. Some weak agglomeration may occur at this time, particularly if the ferrofluid is stored for a long period, and in this case, a physical deagglomeration action can occur, such as a gentle grinding to not damage the particle/functionalizing system. Preferably the deagglomeration is done by ultrasound. In general, the ferrofluid, the standard dispersion to produce MICR ink for ink jet printing has the following characteristics: viscosity between 40 and 400 cP for a suspension of 50% m/m and a pH between 5 and 8. In Table 2, below shows practical results of these Nanum dispersions that are already in the market.

TABLE 2
Physical and chemical properties of magnetic
additives used in MICR ink production.

| | Viscosity | |
|---|---|---|
| Nanumadit | (cP) | pH |
| NA-0701 | 150-200 | 6.5-7.0 |
| NA-0716 | 350-400 | 7.0-8.0 |
| NA-2701 | 300-380 | 6.5-7.0 |
| NA-2801 | 250-350 | 6.5-7.0 |

In general, the requirements for an adequate MICR ink is to have good print quality, stability, do not cause printhead clogging, good magnetic reading, low kogation, and longprinting decap time. The quality of ink printing includes good definition of the printed characters, driven mainly by the physicochemical characteristics of it, such as viscosity and surface tension. The stability of the ink is closely linked to the stability of the dispersion and the dispersion with the mixing of other solvents, thus other solvents which comprises the ink cannot destabilize the initial dispersion. The ink destabilization leads to clogging of the of the printhead nozzles. Another cause of clogging of these orifices is any failure in the process that allows, for example, contamination by dust or other materials. Typically, all the ink undergoes a final filtration process with filter elements of 0.2 microns to guarantee this does not cause clogging.

In addition, another major cause of clogging and printing failure is the drying of ink or the deposition of decomposed ink through the nozzles (kogation). It is necessary to balance the ink drying time in such a way that as soon as the ink jet exits the nozzles, ink blots and scattering does not occur in the already printed substrate and this variable also depends on the printer technology and printing speed. Thus, it is common to use specific and adapted inks to the various printheads and inkjet technologies (thermal, piezoelectric, etc.). This need for fast ink drying on the substrate also leads to the drying of the ink at the edge of the print nozzles when printing stops. In the return of the activities the dry film should be quickly and completely eliminated to avoid compromising the next print quality, so get a good printing decap time is also key. To analyze and monitor the behavior of the ink decap time and kogation 25 cm solid-fill printing evaluations are performed on the time of the cartridge filling and then after resting for 5 minutes, 30 minutes, 1 day, 7 days and 30 days with no external device that stimulates jetting. In none of these cases the print quality may be compromised.

With the dispersions based on functionalized nanoparticles, key feature of this technology presented here, the stability of the ink is not a problem and all eyes are basically focused on print quality, drying time, kogation and decap time.

The production of the MICR ink starts by the manipulation of other solvents (such as -pyrrolidone, n-methyl-pyrrolidone, buthyldiglycol, etc) that comprise the aqueous base and will receive the generated or previously acquired magnetic dispersion. The solvents on this technology contain polyols and other humectants which influence the drying time, penetration of the ink into paper or other substrate, and decap time. From the large amount of existing polyols and other humectants compounds which exhibit excellent performance for this technology the preferred are glycerin, diethylene glycol, polyethylene glycol, etilenoglicolmonoetileter, sorbitol, mannitol, glicereth bis-(cyanoethyl)-dihydroxypropylamine (known as “C-1”), bis-(2-hydroxyethyl) glycolamide (known as “BHEGA”), bis-(hydroxyethyl)-lactamide (known as “BHELA”) and bis-(hydroxyethyl) dimethyl hydantoin (referred to as “DANTOCOL EHD”).

Immediately after homogenizing the aqueous ink base it is added a sufficient amount of the magnetic dispersion (Nanumadit) and new mixing is processed. Depending on the print head and jet firing technology, wetting agents are added to adjust the surface tension, as well as biocides. The ink is then filtered and is ready for storage, supply cartridges, shipment, etc.

In general, the MICR inks are characterized by viscosity up to 18 cPs, a density between 1.2 and 1.7 g/cm³, surface tension between 25 and 55 dyne, conductivity between 500 and 1000 μS·cm-1, neutral pH (˜7), particle size smaller than 200 nm and magnetization between 80% and 200% as measured, for example, using the MICR Qualifier equipment from the RDM Corporation.

Following are examples of the process and products claimed:

### Example I

The formula is manipulated by homogenization of components forming the basis of the ink which is aqueous. To ensure humectation, decap time and printing head protection diethylene glycol (2%), glycerin (1%) and Dantocol DHE (3%) are added plus 2-pyrrolidone (5%) and butyldiglycol (1%) for drying. Besides influencing the drying time, 2-pyrrolidone improves print quality and butyldiglycol allows greater penetration of the ink into the paper. Water completes the base formulation with 28%. The rest 60% is the ferrofluid Nanumadit NA-0701, synthesized such as described in U.S. Pat. No. 8,815,393 B2 and added in a second step. In this formulation ferrofluid contains 50% of solids and is comprised of a cobalt and manganese ferrite functionalized with citric acid using water as the carrier. The ink base plus the ferrofluid is now homogenised for 60 minutes at 230 rpm without heating. biocide was added to control the growth of microorganisms. This ink has for example printed using HP122 cartridge reaching average magnetization of 110% using IDAutomationSCMC7 source; size 12; and paper weights of 120 g/m².

### Example II

In this other formulation, also aqueous, it is added glycerin (7%), BHELA (5%) and polyethylene glycol 6000 (2.5%). Water completes the base formulation with 21.5%. After homogenization the base is added to the magnetic loading (64%)—Nanumadit 0701. Mixing is carried out for 60 minutes more at 230 rpm without heating. The ink is then filtered through 0.5 μm absolute filter. Wetting agents and biocide were added to adjust the surface tension of the cartridge in the acceptable range and control the growth of microorganisms. This formulation has been developed for high-speed printers with piezo printhead, such as Kyocera KJB4 printhead.

### Example III

Another formulation was developed using now Nanumadit NA-0716 additive. It was mixed for humectation diethylene glycol (2%), glycerin (2%) and C-1 (5%) and 2-pyrrolidone (10%) for drying, and print quality. Water is added (26%) to complete the base formulation. In a second step it was added the magnetic loading (55%)—0716 Nanumadit synthesized according to U.S. Pat. No. 8,815,393 B2. In this formulation the ferrofluid contains 50% solids and is comprised of a cobalt and manganese ferrite functionalized with histidine using water as the carrier medium. Homogenization is carried out for 60 minutes at 230 rpm without heating. Wetting agents and biocide were added to adjust surface tension and control the growth of microorganisms. This ink was printed using HP45 cartridge reaching average magnetization of 150% using IDAutomationSCMC7 source; size 12; and paper weights 90 g/m2.

### Example IV

This aqueous base formulation was prepared with the additive Nanumadit NA-2701. For the base of the ink were mixed glycerol (7%), Dantocol DHE (5%), 2-pyrrolidinone (7%), Cab-o-jet 300 (10%) and water (11%). In a second step it was added the magnetic loading (60%)—2701 Nanumadit synthesized as described in U.S. Pat. No. 8,815,393 B2. In this formulation ferrofluid contains 50% solids and is comprised of a cobalt ferrite and barium functionalized with citric acid using water as the carrier medium. The homogenization was performed during 60 minutes at 230 rpm without heating. The ink was filtered through 0.2 μm absolute filter. Wetting agents and biocide were added to adjust surface tension and control the growth of microorganisms. This formulation was developed for high-speed printers with piezo print head, such as the Ricoh Gen4 head.

### Example V

Another aqueous formulation was prepared using the additive Nanumadit NA-2801. Diethylene glycol (1%), glycerin (1%), polyethylene glycol 600 (1.5%), Dantocol DHE (3%), 2-pyrrolidone (5%), butyl diglycol (0.5%) and water (38%) were mixed to form the base of the ink. In a second step was added the magnetic loading (50%)—Nanumadit 2801, synthesized as disclosed in U.S. Pat. No. 8,815,393 B2. In this formulation ferrofluid contains 50% solids and is comprised of a cobalt and cerium ferrite functionalized with citric acid using water as the carrier medium. Homogenization is carried out for 60 minutes at 230 rpm without heating. Wetting agents and biocide were added to adjust surface tension and control the growth of microorganisms. This ink was printed using HP45 cartridge reaching average magnetization of 100% using IDAutomationSCMC7 source; size 12; and paper weights 140 g/m².

### Example VI

For the base of this ink formulation were mixed diethylene glycol (1%), glycerin (2%), BHELA (4%), n-methylpyrrolidone (8%) and water (25%). In a second step the magnetic loading was added (60%)—2812 Nanumadit synthesized as described in U.S. Pat. No. 8,815,393 B2. In this formulation ferrofluid contains 50% solids and is comprised of a cobalt and cerium ferrite functionalized with tartaric acid using water as the carrier medium. The homogenization was performed during 60 minutes at 230 rpm without heating. The ink was first filtered through a 1.0 μm nominal filter and an absolute filter followed by 0.5 μm. Wetting agents and biocide were added to adjust surface tension and control the growth of microorganisms. This ink was printed using HP45 cartridge reaching average magnetization of 120% using IDAutomationSCMC7 source; size 12; and paper weights 90 g/m².

1. A magnetic aqueous ink composition for MICR printing using ink jet printers comprising an aqueous dispersion of functionalized magnetic nanoparticles, humectant solvents and water.

2. A MICR inkjet ink according to claim 1, comprising the initial handling of solvents such as polyols and/or other humectants and further adding and mixing sufficient amount of the functionalized magnetic dispersion.

3. A MICR inkjet ink according to claim 1, which comprises humectants and polyols selected from the following compounds: glycerol, diethylene glycol, polyethylene glycol, etilenoglicolmonoetileter, sorbitol, mannitol, glicereth, bis-(cyanoethyl)-dihydroxypropylamine (known as “C-1”), bis-(2-hydroxyethyl) glycolamide (known as “BHEGA”), bis-(hydroxyethyl)-lactamide (known as “BHELA”) and bis-(hydroxyethyl) dimethyl hydantoin (referred to as “DANTOCOL EHD”).

4. A MICR inkjet ink according to claim 1, comprising a possible addition of wetting agents to adjust the surface tension, as well as the addition of biocides.

5. A MICR inkjet ink according to claim 1, comprising a final filtration process.

6. A MICR inkjet ink according to claim 1, comprising extremely high concentrations of magnetic nanoparticles with loading between 15% and 40% by mass, keeping them stable for several months and creating a system that protects the inkjet print head cartridges against the effect of high ceramic load, having less abrasiveness and more fluidity.

7. A MICR inkjet ink according to claim 1, which is characterized by up to 18 cP viscosity, density between 1.2 and 1.7 g/cm³, surface tension between 25 and 55 dyne, conductivity between 500 and 1000 μS·cm-1, pH neutral (˜7), particle size smaller than 200 nm and magnetization between 80% and 200% as measured, for example, by the RDM MICR qualifier equipment Corporation.

8. A MICR inkjet ink according to claim 1, comprising the use in different applications than MICR inkjet, such as decorative applications, bar codes, texts or hand applications, “roll to roll”, etc.

9. A MICR inkjet ink according to claim 1 comprising nanoscale magnetic ferrites, simple or compounds, chemically synthesized by coprecipitation where their physical and magnetic characteristics can be adjusted as needed. These changes take place by modifying the composition of the metal oxide according to the following criteria for simple ferrite (MFe2O4 or MFe12O19) or compounds ferrites (N×M (1-x) Fe2O4 or N (1-y) Mx+YFE (2-x) O4, for example) where M and N can be metal atoms such as Sm, La, Bi, Ba, Mo, Sr, Ni, Co, Fe, Mn, Cr, etc.

10. A MICR inkjet ink according to claim 1, which comprises the functionalization of the nanoparticles by a surface treatment of them with the addition of a strong acid solution, subsequent washing and addition of a functionalizer, or a combination thereof, chosen from oxalic acids, citric acids, tartaric acids and amino acids.

11. A MICR inkjet ink according to claim 1, which comprises the material obtained after functionalization with adjusted pH and another washing. This second wash process may occur by filtration, dialysis and/or decanting, mixing water and some organic solvents.

12. A MICR inkjet ink according to claim 1, comprising any physical deagglomeration of the functionalized nanoparticles. This disintegration can happen for a conventional or non-conventional grinding, low energy.
